(19) United States
(12) Patent Application Publication
(10) Pub. No.: US 2026/0126981 A1
(43) Pub. Date: May 7, 2026

(54) AUTOMATED UPDATING OF COMPUTING CODE FOR SOFTWARE PLATFORM INTEGRATIONS WITH COMPUTING SERVICES

(71) Applicant: PAYPAL, INC., San Jose, CA (US)

(72) Inventors: Janani Chandiran, Fremont, CA (US); Hui-Tsung Liang, Fremont, CA (US); Robert Thomas McGovern, Omaha, NE (US)

(21) Appl. No.: 18/936,304

(22) Filed: Nov. 4, 2024

(51) Int. Cl. G06F 8/65; G06F 9/54; H04L 51/02

(52) U.S. Cl. CPC G06F 8/65; G06F 9/54; H04L 51/02

(57) ABSTRACT

There are provided systems and methods for automated updating of computing code for software platform integrations with computing services. An online transaction processor or other service provider may provide computing services and platforms to entities including merchants for electronic transaction processing and other account services. To provide for code integrations of the computing services with software platforms, the service provider may provide a tool where merchants may update legacy code integrations of the computing services on their software platforms to new computing code for new code integrations, such as to facilitate the use of new APIs, endpoints, and the like. The tool may provide mappings for legacy code parameters to new code parameters, which may each be associated with code limitations in the legacy code and new code integrations. Further, the tool may provide an automatic converter of the legacy code to the new code using these mappings.

### TECHNICAL FIELD

The present application generally relates to computing code updates of software integrations, and more particularly to providing an automated tool and interface for updating legacy code integrations of software platforms with computing services.

### BACKGROUND

Online service providers may offer various services to end users, merchants, and other entities. This may include providing computing services through different software applications, websites, platforms, and resources, such as those that may be involved with digital transaction processing. For example, computing services may include those used to process transactions through electronic transaction processing data flows, services, and other computing resources. Further, the service provider may provide and/or facilitate the use of applications and websites for online payments, peer-to-peer (P2P) transfers, and/or marketplaces to different entities including merchants.

Establishment and use of these computing services require that merchants and other entities implement computing code for application programming interface (API) calls and other operations to be executed with these computing services and their APIs.

However, a service provider may have many merchants, partner platforms, customers, and other entities that may be integrated with the service provider's computing services, which may utilize legacy patterns of executable computing code from past, previous versioned, or legacy software development kits (SDKs) and APIs.

Internal teams of the service provider may not have a central system and tool that provides visibility into the integration patterns and code used by these entities to make informed decisions on guiding the entities to the latest tools, computing code, APIs, and services offered by the service provider. As such, there exists a need for a more streamlined and accessible platform and tool that automates computing code updates from legacy computing code to new computing code that allows for use of the latest computing services and their implementations with the service provider.

### BRIEF DESCRIPTION OF THE DRAWINGS

FIGS. 1A and 1B are block diagrams of networked systems suitable for implementing the processes described herein, according to an embodiment;

FIGS. 2A and 2B are exemplary diagrams of a detection tool for detection and presentation of integration patterns and code utilized by software platforms with corresponding updates available for new computing code, according to an embodiment;

FIGS. 3A and 3B are exemplary diagrams of a code transformation tool that transforms legacy computing code for integrations of software platforms with computing services to new computing code, according to various embodiments;

FIG. 4 is a flowchart for automated updating of computing code for software platform integrations with computing services, according to an embodiment; and FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for automated updating of computing code for software platform integrations with computing services. Systems suitable for practicing methods of the present disclosure are also provided.

Conventionally, during setup of an account and software platform for use and integration with computing services provided by a service provider, merchants and other entities may onboard with the service provider and implement computing code for cross-platform API calling, communications, and service usage. For example, a merchant may onboard to obtain access to accounts and computing services and utilize corresponding services during the course of their business or other interactions with customers, clients, and the like. This may include accessing computing service setups including software development kits (SDKs) and SDK setup/documentation, API call configurations and samples, API documentation and call structures, code snippets and packages, and other data for code integrations of the service provider's computing service(s) with the merchant's software platform. Other software platform setups may include code configurations and integrations for applications and/or websites. However, the service provider's computing architecture may evolve over time as new computing services become available, code and processors become updated or upgraded, new or updated APIs are released, and the like. Merchants and other entities would be required to manually search for and locate these new integrations and code for computing services and other products of a service provider, as well as look up API documentation, computing code snippets, SDKs, and the like for new and changing integrations from the “legacy” or past, outdated, or older versioned code and APIs.

Merchants and agents of the service provider (e.g., code developers and merchant code integration assistants) may typically use various tools to stitch a high-level view of the merchant/partner's integration, such as a merchant monitor, software for searching and analyzing logs or interactions with software platforms, API and/or network traffic logs, etc. Since merchants and other entities may have multiple manners and processes to integrate with the service provider, there is not a standard or clear process to inform merchants of their integrations and what they have integrated. As such, this process is time and labor intensive, and may lead to inefficient or suboptimal solutions, thereby creating computing systems that waste computing resources, processing power, and/or encounter errors and failures. Further, as merchants are moved to the latest integrations with computing services, the service provider may find it beneficial to inform merchants of how well they have integrated with the service provider to offer suggestions, integration improvements, new computing code, APIs, and/or other integration options for computing service usage.

For example, merchants may offer products, such as goods, services, and other items, for sale to users via merchant software platforms including websites, software applications (e.g., mobile and/or native applications for different operating systems). As such, a user may wish to process a transaction to purchase an item from a merchant via one of these software platforms, such as for a payment to the merchant through an online service provider. The user may pay for one or more transactions with a merchant using a digital wallet or other account with the online service provider, such as a digital transaction processor (e.g., PayPal®). The merchant may utilize these online service providers for particular computing services, such as to process transactions, create and/or login to accounts with the service provider and/or the merchant, provide risk analysis and/or fraud detection, and other computing services provided through applications, websites, resources, and processors of the service provider. Other service providers may also provide different services to other types of entities, such as computing services for social networking, microblogging, media sharing, messaging, business and consumer platforms, and the like.

As such, the merchant (or other entities) may have software platforms, such as applications and websites, where the merchants may offer their goods, services, and other items to users, such as customers and consumers. During the provision of such items, the merchant may desire to incorporate the service provider's computing services within their software platform so that services may be provided and/or accessed via the merchant's platform in place of requiring users to navigate to the service provider's application, website, and/or other platform. In order for merchants to provide the services of the service provider to users for processing transactions with the merchants, the service provider may provide operations for merchants to perform computing code integrations with the service provider through one or more merchant websites, systems, applications, and the like. However, after initial onboarding and integrating of software platforms with the computing services, over time the integrations may become “old” or outdated, such as by relying on past or legacy versions of computing code, APIs, and/or computing services of the service provider, which may be inefficient, less secure, and/or provide suboptimal computing interactions and experiences, as well as offering less computing services and resources to the merchants. To overcome the cumbersome manual efforts required to update code, merchants may utilize an integration discovery tool and API call transformer that may automate code integrations and updates to legacy integrations in order to utilize more efficient, faster, more secure, and/or improved computing service usage and implementation.

As such and to address these issues with conventional systems, a service provider, as discussed herein, may provide a discovery tool and API call and/or code transformer that may assist merchants and other entities with computing code integrations and updates of such integrations. These tools, transformers, and other operations and applications may be provided through an online platform that may be accessible by merchants to integrate the merchants' software platforms with computing services and other products of the service provider, as well as provide automated code generation and/or migration of code integration to the most recent, updated, and/or newest available code of the service provider.

A merchant, or the merchant's employees, code developers, agents, employees, and the like, may access an online digital platform where the user(s) may view the existing integrations of a software platform with the computing services and other products of the service provider, such as by viewing the current version, computing code, and/or information for the software integrations that exist on the merchant's software platform and/or with the computing services of the service provider. A “merchant” may refer to a single user or group of users, which may provide one or more items for sale and/or otherwise facilitate the sale of products (e.g., goods, services, and other items) to users. However, a merchant may also refer to an entity, such as a business or company, involved in the sale of items to customers and consumers. As such, merchant entities may include and/or utilize code developers, agents, employees, and other persons or users during the course of their business and to perform the code integration updates discussed herein. Merchant may also utilize automations during the performance of code integration updates including transformations of legacy code to new code, as described herein. These automations may include automated computing scripts, software applications, AI systems including generative AIs, chatbots, and the like.

In this regard, a portal accessible by a merchant and/or a user associated with a merchant may include one or more personalized and/or customized user interfaces (UIs) where users may view information regarding the computing services and code integration for computing services of the service provider that are utilized by the software platform of the merchant. The information presented for the code integrations may be retrieved, determined, and/or loaded in the UIs from existing knowledge and/or stored data for the code integrations that the merchant has performed with the computing services of the service provider. For example, the merchant may be onboarded and setup with the service provider for computing service usage through an onboarding and/or setup process, which may establish the code integrations. Code integrations may have been implemented with software platforms that call the computing services, such as through one or more API calls, which may establish and/or identify the computing code used, API call structure, form, and/or data, and the like for those code integrations.

In some embodiments, the service provider and/or the discovery tool may call the merchant's computing systems, APIs, and other components of the merchant's software platform to determine the code integrations currently used by the merchant and/or implemented with the merchant's systems. This may include transmitting API calls to the APIs of the merchant's software platform through known endpoint identifiers and/or configurations, as well as performing pings and executing request and response calls with such APIs of the merchant's software platform. The merchant's software platform may respond with information regarding the existing code integrations or may transmit response calls that may be analyzed to determine such integrations. Once determined, the discovery tool may present one or more UIs where the merchant may view the existing code integrations including information for the code integrations. Such information may include the computing service used, the API request/response parameters, other call parameters, an integration type, an integration platform, and/or an integration channel, although other information may also be presented.

Thereafter, the discovery tool may provide a code transformer to generate code integrations and/or update or migrate existing code integrations (e.g., legacy integrations using legacy code) to new code integrations. The code transformer may correspond to a tool, operation, and/or application that may be provided through the platform of the merchant for code integration generating and updating. The code transformer may therefore provide one or more UIs where selections of code parameters, legacy code implementations, and the like may be made manually or automatically (e.g., by a computing script, generative AI, etc.), and new code integrations, code samples or formats, and code limitations may be output for viewing, use, and/or implementation. For example, the code transformer may provide one or more UIs where an integration stack (e.g., a legacy or existing integration of the merchant's software platform), an API, a transformation stack (e.g., a target or new integration of the merchant's software platform, such as to transform the legacy integration), a transformer processing flow, and/or an integration field may be selected for code transformations. The UI(s) may also allow specification of the API parameters or other code parameters that the merchant would like transformed to the new code.

The code transformer may then use mappings to transform legacy code for the past or existing code integration of the merchant's software platform to the new or updated code integration that is available from the service provider. The mappings may correspond to information in a data structure that shows the legacy code integration mapped to the new or updated code integration, as well as allow transformation of code between the integrations. In one example, a data table may include rows, each for a different parameter's mapping, where the columns include the requested parameter from the legacy code (e.g., the parameter selected in the UI(s) and/or code transformer's tool) with a legacy code limitation mapped to the new or target parameter with a corresponding code limitation. Each mapping may be generated by a code developer and may therefore allow a user to view a legacy API/code parameter, a legacy limitation, a new API/code parameter, and a new limitation. Further, these mappings enable the code transformer to transform legacy code limitations for specific parameters of the merchant's integration to the new code limitations for the same or similar parameters.

In this regard, using the UI(s) of the code transformer, computing code for an integration and/or integration update of each computing service (e.g., through API call structures and configurations, code snippets, SDKs, etc.) may be provided to the merchant through code parameter and limitation mappings and transformations. The code transformer may further allow the merchant to provide sample code, such as a current or legacy API call structure with corresponding data for the call parameters, and have the code transformed to the current version or code for service integration with the merchant's software platform. A code developer or other user, as well as a script, generative AI, or other automation, may sample code, such as an API call structure with a header, body/payload, digital signature, and/or authenticity field, etc., and may determine how the code may be implemented and integrated with their software platform for use of and/or calls to the computing service. The code review window or UI may provide instructions for code integration and/or use. The UI(s) of the code transformer, discovery tool, and/or platform of the service provider may therefore display dynamic and customized data for code integration updating and implementing with software platforms.

Further, one or more chatbots may facilitate use of the discovery tool and/or code transformer, such as by employing an LLM or other generative and/or conversational AI to communicate with the merchant's developer, agent, employee, or other user, provide responses to questions, and process merchant inputs to utilize the discovery tool and/or code transformer automatically. For example, a chatbot may execute a command to call the merchant's software platform and determine API call data for the discovery tool, or make selections with the code transformer for requested parameters to display or output mapped parameters with mapped code limitations to the merchant. As such, the service provider may leverage and utilize specifically designed tools, applications, and platforms with generative AIs to assist merchants with integrating computing services on software platforms in a faster and more seamless manner. The discovery tool allows for merchants to automate processes to determine code capabilities and patterns for existing code integrations seamlessly and with minimal manual efforts so that a centralized data hub and/or UIs may be presented with data in a consolidated view for reduced data searches and presentations. Further, the code transformer may automate code transformations between different coding formats, platforms, and changes to parameters so that new code limitations and samples may be provided more efficiently for optimized code integrations. As such, the service provider may provide an improved computing platform for computing services that are utilized by external and third-party software platforms.

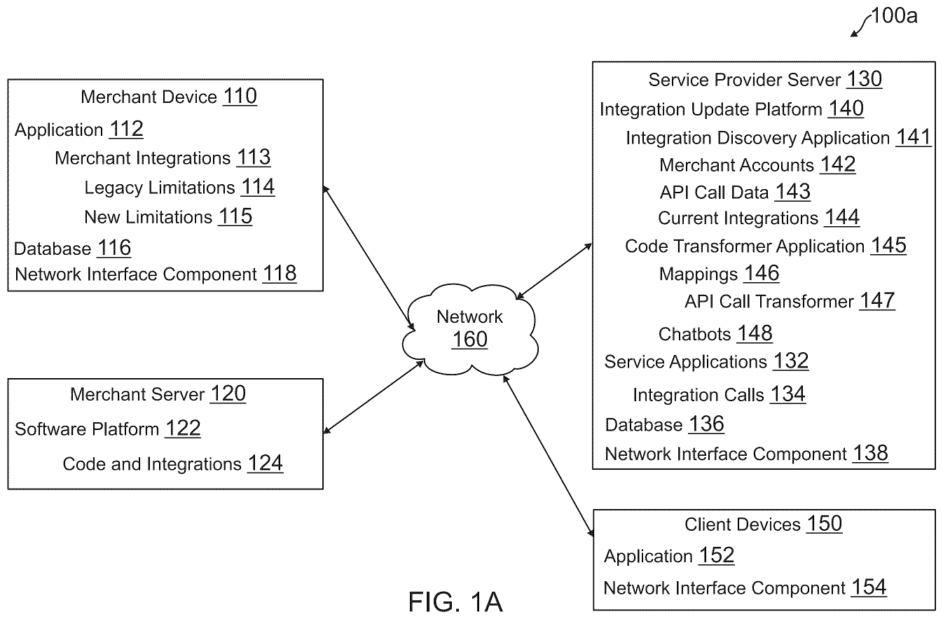

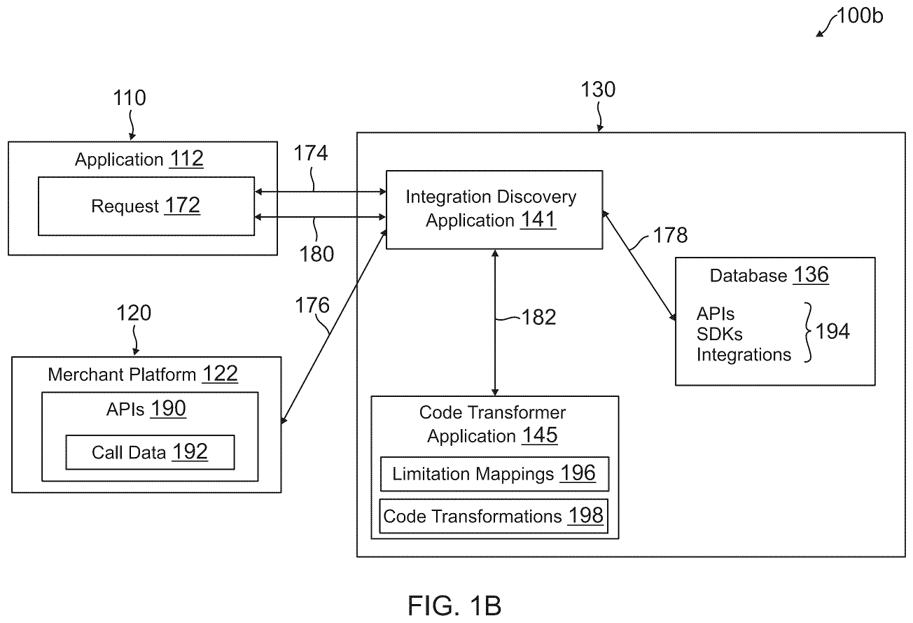

FIGS. 1A and 1B are block diagrams of networked systems 100a and 100b suitable for implementing the processes described herein, according to an embodiment.

As shown, system 100a may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, and/or another suitable device and/or server-based OS. It can be appreciated that the devices and/or servers illustrated in FIG. 1A may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100a includes a merchant device 110, a merchant server 120, a service provider server 130, and a client device 150 in communication over a network 160.

Merchant device 110 may be utilized by a merchant or other user to communicate over network 160 with service provider server 130, where service provider server 130 may provide various data, operations, and other functions over network 160 to facilitate usage of computing services with merchant server 120. In this regard, merchant server 120 may be used to provide products and services to consumers and customers through one or more software platforms, which may incorporate the services of service provider server 130 on such platforms. As such, merchant device 110 may be utilized to configure merchant server 120 including developing and updating a software platform 122 to utilize computing services provided by service applications 132 of service provider server 130. Service provider server 130 may provide a discovery tool and code transformer to facilitate code integrations and migrations for computing service usage. Merchant server 120 may then be accessed and used by client device 150, such as by a customer or consumer to purchase items, which may utilize the integrated computing services.

Merchant device 110, merchant server 120, service provider server 130, and client device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100a, and/or accessible over network 160.

Merchant device 110 may be implemented as a communication device that may utilize appropriate hardware and software configured for wired and/or wireless communication with merchant server 120 and service provider server 130 over network 160. For example, in one embodiment, merchant device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data.

Although merchant device 110 is shown as a singular device, a plurality of devices, servers, and/or computer systems may function similarly and/or be connected to provide the functionalities described herein. For example, merchant device 110 may correspond to a device of a code developer of a merchant, as well as multiple devices of multiple code developers working in tandem and/or collectively to provide code development and updating for computing service integrations, as discussed herein. Merchant device 110 may also correspond to one or more servers of a merchant computing system, as well as devices that may be used by various developers, agents, employees, and other users associated with a merchant.

Merchant device 110 of FIG. 1A includes and/or is associated with an application 112, a database 116, and a network interface component 118, implementations of which are discussed further below. The application 112 may correspond to executable processes, procedures, and/or applications with associated hardware. In other embodiments, merchant device 110 may include additional or different modules having specialized hardware and/or software as required.

Application 112 may correspond to one or more processes to execute software modules and associated components of merchant device 110 that may be utilized to access the features, services, and platforms provided by service provider server 130. Application 112 may be used for development of software platforms of the merchant and integration of the software platforms with the computing services provider by service provider server 130. For example, application 112 may correspond to a browser application or native software application that may be utilized to configure software platform 122 on merchant server 120 and/or access an integration update platform 140 on service provider server 130 for use with configuring software platform 122. When accessing integration update platform 140, an interface of application 112 may be used to view merchant integrations 113 corresponding to the legacy, current, and/or new code integrations of computing services of service provider server 130 on software platform 122. In some embodiments, the computing services of service provider server 130 that may be viewed and implemented with software platform 122 may include processes for merchant sales, transaction processing, inventory, return or exchange, risk analysis, and other services a merchant may require during the course of their business and sales through software platform 122, such as to provide, market, and/or sell products, services, and other items to customers and/or assist customers with purchases.

As such, a merchant, code developer of the merchant, merchant agent, or the like may utilize application 112 and view one or more UIs for a corresponding website or application of integration update platform 140 associated with service provider server 130. The UIs may enable the developer to engage in development of software platform 122 by integrating computing services of service provider server 130 with software platform 122 via integration update platform 140. For example, merchant integrations 113 may be displayed via the UIs and include legacy limitations 114 for past and/or current code limitations and computing code implementations of code integrations of software platform 122 on merchant server 120, as well as new limitations 115 for new, proposed, transformed, and/or suggested code limitations and computing code implementations of those code integrations. For example, merchant integrations 113 may include information for the computing code of software platform 122, those integrations that may be performed by legacy limitations 114 of computing services and API calls with software platform 122, and/or new limitations 115 of computing services and API calls usable with software platform 122. As such, legacy limitations 114 and new limitations 115 may include configured code snippets, code packages, SDKs and SDK operations, APIs and endpoints, and the like.

Application 112 may be accessible by users via a general browser application and/or general, native, and/or local mobile application configured to retrieve, present, and communicate information over the Internet (e.g., utilize resources on the World Wide Web) or a private network. For example, application 112 may correspond to a website accessible via a web browser, which may send and receive information over network 160, including retrieving website information (e.g., a website for an email provider or other messaging service), presenting the website information to the user, and/or communicating information to the website. Application 112 may correspond to application data accessible via a dedicated software application provided by the merchant or other entity. Application 112 may be associated with merchant accounts and account information for products of service provider server 130 used by the merchant and/or on software platform 122, account information, user financial information, and/or transaction histories, which may be associated with electronic transaction processing services provided by service provider server 130 for merchants.

Merchant device 110 may further include or have access to database 116, which may correspond to different types of data storage and components including cloud computing storage nodes, remote data stores and database systems, distributed database systems over network 160, and the like used to store various applications and data. Database 116 may include, for example, identifiers such as operating system registry entries, cookies associated with application 112 and/or other applications, identifiers associated with hardware of merchant device 110, and/or other appropriate identifiers, such as identifiers used for payment/user/device authentication or identification, which may be communicated as identifying the merchant and/or customer to service provider server 130.

Merchant device 110 includes at least one network interface component 118 adapted to communicate with merchant server 120, service provider server 130, client device 150, and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Merchant server 120 may be maintained, for example, by a merchant that may utilize software platform 122 to provide products to users, such as items and services for sale, which may be browsed and purchased through an online digital platform and via computing devices including client device 150. In this regard, merchant server 120 may provide software platform 122 through a native software application and/or website and browser applications. Software platform 122 may offer products to users, such as items and services for sale, which may utilize the computing services of service provider server 130 through computing code integrations. Merchant server 120 may provide software platform 122 to client device 150 for engagement with the merchant's products and use of integrated computing services, as discussed herein. In one example, merchant server 120 may be provided by a merchant or multiple merchants including a merchant marketplace provider that allows multiple merchants to offer products for sale. However, in other embodiments, merchant server 120 may correspond to another type of entity that may have and/or utilize a software platform accessible via a native software application and/or a browser application of the client devices for users to access and view data, as well as engage with integrated computing services of service provider server 130.

Merchant server 120 of FIG. 1A includes and/or is associated with software platform 122, implementations of which are discussed further below. Software platform 122 may correspond to executable processes, procedures, and/or applications with associated hardware. In other embodiments, merchant server 120 may include additional or different modules having specialized hardware and/or software as required.

Software platform 122 may correspond to one or more processes to execute modules and associated specialized hardware of merchant server 120 to provide an online digital platform where users may access data for a merchant or other entity via an application, such as a resident software application and/or a browser application. In this regard, software platform 122 may correspond to specialized hardware and/or software that may provide software platform 122 for access by devices including client device 150. In some embodiments, software platform 122 may be used to offer and/or provide products for sale, such as items and/or services. However, other types of platforms, data, and the like may also be provided over network 160 to client device 150 and other devices and servers, such as those associated with social networking, microblogging, media sharing, messaging, business and consumer platforms, etc. Software platform 122 may be configured to include and/or utilize computing services of and/or provided by service provider server 130, such as through code and integrations 124 that may include and/or utilize APIs and API calls specifically configured by integration update platform 140 of service provider server 130 to call service applications 132 and utilize such computing services.

In this regard, software platform 122 may provide features, services, and other operations to customers of a merchant, which may include merchant sales operations, POS device processing and/or operations, online merchant marketplaces, sales and inventory services, and the like. Software platform 122 may include code and integrations 124 that correspond to computing code, API calls and/or call structures, code dependencies, and the like. Code and integrations 124 may include legacy computing code, code dependencies, API calls and call structures, and/or other code integrations, which may be required to be updated and/or reconfigured to utilize new computing code, integrations, and/or API calls to current API and/or computing services and/or versions of such APIs/services. Computing services implemented on or through software platform 122 may be provided using code and integrations 124, such as code integrations of those computing services associated with an account, payment and/or electronic transaction processing services, and the like. As such, software platform 122 may utilize such computing services of service provider server 130 with the merchant's customers through code and integrations 124.

In some embodiments, the computing services implemented and integrated with software platform 122 may further include processes for merchant sales, inventory, return or exchange, risk analysis, and other services a merchant may require during the course of their business and sales, such as to provide, market, and/or sell products, services, and other items to customers and/or assist customers with purchases. In this regard, software platform 122 may correspond to specialized and/or specifically configured computing code developed by a merchant, developer, or other user via merchant device 110, such as code and integrations 124, to provide applications, websites, resources, and data based on the account and/or computing services. Software platform 122 may provide and/or process items for sale with client device 150 and/or a user interacting with software platform 122 via client device 150 and/or another computing device (e.g., a POS device, etc.). In certain examples, software platform 122 may be accessible over the Internet and provide for sales with client device 150 over network 160. Software platform 122 may utilize code and integrations 124 to interact with service provider server 130.

In some embodiments, software platform 122 may correspond to and/or be used to configure a checkout application at a physical merchant location, such as the application(s) of a point-of-sale (POS) device used to provide sales at physical locations. For example, software platform 122 may be used to establish a transaction once a user/employee associated with client device 150 has selected one or more items for purchase and/or entered the item(s) to the transaction for processing. Once a payment amount is determined for the item(s) to be purchased by the user, software platform 122 may request payment for the transaction. Payment may be provided using electronic transaction processing services enabled and/or provided to merchant server 120 after incorporating and/or integrating computing services of service provider server 130. Such computing services may be integrated and/or migrated to new or updated integrations using integration update platform 140, as discussed herein. Payment may be received from a user and may be processed using merchant server 120 using code and integrations 124 with computing services of service applications 132, such as using code and integrations 124 to call service provider server 130. After receipt of payment and/or confirmation of the payment, software platform 122 may then process a payment to the merchant.

In some embodiments, software platform 122 may be used to host, provide, and/or access and maintain a website of the merchant, a web-based application, or the like, which may also be configured based on computing services provided by service provider server 130 and implemented using code and integrations 124. The website may be operated, hosted, updated, and provided to end user devices and other systems or servers. The website may correspond to a hosted website having webpages that may include parent and child webpages where customers and service providers may browse items and other services provided by a corresponding merchant, engage in electronic transaction processing, provide customer support and feedback, and the like. The website may be provided through one or more webpages having of Hypertext Markup Language (HTML) code, Extensible Markup Language (XML) code, JavaScript code, and/or Cascading Style Sheets (CSS). In other embodiments, software platform 122 may provide data for an application that may be installed on client devices of users and used to access the merchant's data, marketplace, items, and the like, as well as use the computing services of service provider server 130 through such application. As such, merchant server 120, and software platform 122 in particular, may interact with integration update platform 140 to provide information for software platform 122 and implement code integrations, transformations to migrate legacy code to new code integrations, and the like.

Service provider server 130 may be maintained, for example, by an online service provider, which may provide computing services and operations via one or more digital platforms, applications, websites, and the like. Service provider server 130 may provide computing services to various entities by providing integrations of computing code for API call execution and other operations using integration update platform 140, as discussed herein. In one example, service provider server 130 may be provided by PAYPAL®, Inc. of San Jose, CA, USA. However, in other embodiments, service provider server 130 may be maintained by or include another type of service provider.

Service provider server 130 of FIG. 1A includes and/or is associated with integration update platform 140, service applications 132, a database 136, and a network interface component 138, implementations of which are discussed further below.

Integration update platform 140 and service applications 132 may correspond to executable processes, procedures, and/or applications with associated hardware. In other embodiments, service provider server 130 may include additional or different modules having specialized hardware and/or software as required.

Integration update platform 140 may correspond to one or more processes to execute modules and associated specialized hardware of service provider server 130 to provide an online digital platform for merchants, developers, and other entities to discover, view, and/or update computing code integrations with their software platforms. In this regard, integration update platform 140 may correspond to specialized hardware and/or software used by a merchant or other user associated with merchant device 110 to provide operations for identification of legacy code integrations (e.g., past, previous, older versioned, and/or unsupported) and/or existing code integrations of the computing services of service provider server 130 on or with software platform 122 for merchant server 120. Integration update platform 140 may further provide processes for updating or transforming those code integrations for newer or current versioned/generation integrations, such as to use the updated versions of and/or new APIs, computing services, processors, and the like. In this regard, integration update platform 140 may include an integration discovery application 141 that may be used by merchant device 110 to discover and determine the legacy and/or existing code integrations and a code transformer application 145 to transform those legacy/existing code integrations to new, current, and/or updated code integrations.

When merchant device 110 initially utilizes integration update platform 140, application 112 may request information for discovery and/or determination of the code integrations that may have been or are currently used by software platform 122 with the computing services provided by service applications 132, such as to send/receive integration calls 134 for computing service usage. Those code integrations may have been implemented with software platform 122 as a result of a merchant onboarding, computing service integration and/or usage, and/or code migration. As a result, code and integrations 124 may have existing, current, and/or legacy code integrations on software platform 122, which may require an update to new and/or updated code integrations.

Based on this request, integration discovery application 141 may process merchant accounts 142, API call data 143, and/or current integrations 144 to present merchant integrations 113 in application 112 on merchant device 110.

For example, merchant accounts 142 may include data for merchant onboarding, past calls and data processing requests by software platform 122 with service applications 132 and/or other data for past interactions and/or activity that may indicate the integrations used by code and integrations 124 with service applications 132. API call data 143 may include data for API calls transmitted to software platform 122 by integration discovery application 141 to discover or determine data for code and integrations 124, such as API requests and responses for code integration information from software platform 122. As such, current integrations 144 may be determined, which may include those past and/or existing integrations being previously and/or currently utilized by software platform 122.

Code transformer application 145 may then allow for integration update platform 140 to determine and make suggestions or recommendations of code transformations and updates to merchant device 110 for use with software platform 122, such as to update code and integrations 124. Mappings 146 may correspond to a data table or other data set that identifies legacy parameters for API calls and other code integrations and correlates those legacy parameters to new and/or target parameters for the updated code integrations. As such, a merchant may determine the parameters for the updated code integrations by providing the parameters of their legacy and/or current integrations. With the mapped parameters, each parameter may have a correlated code limitation, such as a code snippet, statement, argument, or segment that enables implementation of the parameter and its function in computing code. For example, a code limitation may have a language and/or format that may be implemented in computing code to cause execution of the corresponding function of the parameter.

Code transformer application 145 may provide mappings 146 so that legacy limitations 114 may be viewed with new limitations 115 in application 112. Code transformer application 145 may further provide an API call transformer 147 via one or more UIs, which may correspond to a tool and process where the merchant may enter code for their legacy limitations 114 and have the code transformed to new limitations 115 using mappings 146, such as by restructuring the code based on the code limitations for each mapped parameter in the computing code. For example, legacy API calls to a legacy API may be to an older version of the API, where the new or current version of the API for the computing service uses a representational state transfer (REST) API and REST endpoints. As such, an API specification of the new REST API may designate such REST endpoints, and mappings 146 may be used to show code for the legacy API calls to the endpoints of the legacy API that are mapped to code that may be used to execute new API calls to the REST API endpoints.

When providing the integration discovery and code transformation services, integration update platform 140 may provide one or more UIs, as well as chatbots 148 to assist merchants with code integration updates using integration discovery application 141 and code transformer application 145. Chatbots 148 may be provided using one or more large language models (LLMs), deep learning and neural networks (NNs), rule-based engines, and/or other generative artificial intelligences (AIs). Chatbots 148 may provide an automated question-and-answer service whereby merchants may provide requests for integration discovery and/or transformation, and chatbots 148 may invoke the operations of integration discovery application 141 and/or code transformer application 145 to provide conversational responses with code integration updates to the merchant via application 112.

Service applications 132 may correspond to one or more processes to execute modules and associated specialized hardware of service provider server 130 to process a transaction and/or provide other computing services to users. For example, service applications 132 may be used to process payments and other services to one or more users, merchants, and/or other entities for transactions, where merchants may integrate use of one or more of service applications 132 through code integrations performed, updated, and managed by integration update platform 140. In this regard, service applications 132 may be used to send and receive payments, including those payments that may be enabled through the website and/or application corresponding to software platform 122 after integrating use of those services. A merchant payment account for use of these services may be accessed and/or used through a browser application and/or dedicated payment application, which may allow for use of the computing services on and/or with software platform 122. Service applications 132 may process payments and may provide transaction histories to software platform 122 and/or another user's device or account for transaction authorization, approval, or denial of the transaction for placement and/or release of the funds, including transfer of the funds between accounts.

Further, service applications 132 may provide different computing services, including social networking, microblogging, media sharing, messaging, business and consumer platforms, etc. These computing services may be used by customers and users, such as through user devices, and may be implemented on different merchant platforms, websites, and/or applications. For example, software platform 122 may implement one or more of the computing services of service applications 132 and may call those services using those integrations through integration calls 134. Integration calls 134 may be used to process data with software platform 122 and provide requests and responses for data processing. For example, integration calls 134 may be performed by software platform 122 using code and integrations 124, which may include legacy integrations having legacy code identified in application 112 by legacy limitations 114 and new code updates and changes identified in application 112 by new limitations 115.

Service applications 132 may provide additional features to service provider server 130. For example, service applications 132 may include security applications for implementing server-side security features, programmatic client applications for interfacing with appropriate application programming interfaces (APIs) over network 160, and/or other types of applications. Service applications 132 may contain software programs, executable by a processor, including one or more GUIs and the like, configured to provide an interface to the user when accessing service provider server 130, where the user or other users may interact with the GUI to view and communicate information more easily. Service applications 132 may include additional connection and/or communication applications, which may be utilized to communicate information to over network 160.

Additionally, service provider server 130 includes or may access database 136. Database 136 may store various identifiers associated with merchant device 110, as well as account data, including payment instruments, financial information, account balances, and authentication credentials, as well as transaction processing histories and data for processed transactions. Database 136 may include information for merchants that may be used to recommend computing services and code integrations to merchants. Although database 136 is shown as residing on service provider server 130 as a database, in other embodiments, other types of data storage and components may be used including cloud computing storage nodes, remote data stores and database systems, distributed database systems over network 160 and/or of a computing system associated with service provider server 130, and the like.

Service provider server 130 may include at least one network interface component 138 adapted to communicate with merchant device 110 and/or other devices and servers over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Client device 150 may be implemented as a computing device of a user, such as a consumer or a customer of a merchant associated with merchant server 120, that may utilize appropriate hardware and software configured for wired and/or wireless communication with merchant server 120 and/or service provider server 130. For example, client device 150 may be utilized by a consumer to access software platform 122 to browse items for sale and engage in electronic transaction processing. Client device 150 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly, such as those of a plurality of consumers engaging in shopping and purchasing from the merchant via software platform 122.

Client device 150 of FIG. 1A contains an application 152 and a network interface component 154. Application 152 may correspond to executable processes, procedures, and/or applications with associated hardware. In other embodiments, client device 150 may include additional or different modules having specialized hardware and/or software as required.

Application 152 may correspond to one or more processes or applications to execute software modules and associated components of client device 150 to provide features, services, and other operations for a user, which may include accessing software platform 122 and/or engaging in use of computing services provided by service provider server 130 via software platform 122. In this regard, application 152 may correspond to software utilized by a user of client device 150 to access a website or application data (e.g., for a mobile application, rich Internet application, or resident/native software application) that may display one or more UIs that allow for interaction with software platform 122, for example, to browse items for sale, select and/or checkout for items, process transactions electronically (e.g., perform electronic transaction processing for items, send/receive payments, etc.), login to accounts, and/or receive receipts and transaction histories. Thus, application 152 may display data for software platform 122 that allows the user to interact with software platform 122 via the UI(s) displaying data for the merchant's items for sale, offers, advertisements, and other information on software platform 122. Application 152 may enable the use integrated computing services for service applications 132 of service provider server 130 on software platform 122. As such, in various embodiments, application 152 may correspond to a general browser application configured to retrieve, present, and communicate information over the Internet (e.g., utilize resources on the World Wide Web) or a private network. However, in other embodiments, application 152 may include a native and dedicated application associated with merchant server 120, service provider server 130, and/or another entity that may access data for and/or present software platform 122 on client device 150.

Application 152 may be associated with account information, user financial information, and/or transaction histories for electronic transaction processing, including processing transactions using financial instrument or payment card data on software platform 122 using integrated computing services established and/or updated with code and integrations 124, as discussed herein. Application 152 may be utilized to enter, view, and/or process items the user wishes to purchase in a transaction, as well as perform peer-to-peer payments and transfers, using the integrated computing services. A payment may be requested to be made on software platform 122 using the integrated services, and application 152 may be used to specify user financial information, such as credit card data, bank account data, or other funding source data, as a payment instrument when providing payment information to service provider server 130. Additionally, application 152 may utilize a digital wallet associated with an account with a payment provider as the payment instrument, for example, through accessing a digital wallet or account of a user through entry of authentication credentials and/or by providing a data token that allows for processing using the account. Application 152 may receive a receipt or other information based on transaction processing of the transaction. In some embodiments, additional services may be provided via application 152, including social networking, media posting or sharing, microblogging, data browsing and searching, online shopping, and other services available through service provider server 130.

In some embodiments, application 152, whether native or accessed via the web (e.g., where application 152 may correspond to a web browser accessing a webpage served to client device 150 by merchant server 120), may be required to be updated to utilize the latest interface, functionalities, computing service integrations, and other updates to software platform 122. As such, when code and integrations 124 are updated for software platform 122, application 152 may similarly be updated. Such updates to application 152 may be based on new limitations 115 and/or changes to application 152 made by service provider server 130. For example, if software platform 122 is updated and/or upgraded to utilize a latest checkout service, application 152 may be required to be updated to match such functionalities. Application 152 may be updated to utilize software platform 122; however, in many embodiments where software platform 122 is updated to use new and/or upgraded computing services of service provider server 130, application 152 may be updated by service provider server 130 to utilize such computing services with software platform 122, service applications 132, and/or other platforms that may utilize and/or integrate such computing services. As such, updates to application 152 may not be strictly controlled by, tied to, or occur simultaneously to the updates, changes, and/or upgrades of software platform 122, but may instead be performed to enable application 152 to properly utilize and/or function with the computing services of service provider server 130.

Client device 150 includes at least one network interface component 154 adapted to communicate with merchant server 120, service provider server 130, and/or another device or server. In various embodiments, network interface component 156 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100a.

Referring now to system 100b in FIG. 1B, a detailed implementation of the calls and data exchanges between the devices, servers, and other components from system 100a is shown. For example, in system 100b, merchant device 110 may interact with service provider server 130 to configure and update computing code integrations of computing services provided by service provider server 130 with software platform 122 on merchant server 120. To initiate a process to update a code integration on software platform 122, application 112 on merchant device 110 may transmit a request 172 to integration discovery application 141 via communications 174. Request 172 may correspond to a data processing and retrieval request for discovery of the computing code integrations that currently exist and/or were previously used by software platform 122 to call and utilize the computing services of service provider server 130, such as to provide those computing services via software platform 122. As such, communications 174 may correspond to an API call to an API of integration discovery application 141 to establish communications and process a request 172 in order to present the current, existing, and/or legacy computing code integrations of software platform 122 with the computing services of service provider server 130.

To perform code integration discovery and presentation of those current, existing, and/or legacy computing code integrations on merchant device 110, integration discovery application 141 may execute API calls 176 to software platform 122. API calls 176 may correspond to request/response, ping, or other informational calls transmitted between integration discovery application 141 and APIs 190 of software platform 122, such as to determine call data 192. For example, APIs 190 of software platform 122 may be called via API calls 176 with one or more requests to respond with call data 192 in order to determine the data, structure, and other information for existing API calls that software platform 122 performs and/or utilizes when calling the computing services of service provider server 130. This allows for integration discovery application 141 to determine the capabilities and integrations of software platform 122 with those computing services. In addition to performing API calls 176, integration discovery application 141 may execute fetch commands 178 and/or other database retrieval calls to database 136 for past merchant integration data 194, such as the APIs, SKDS, and/or integrations known and/or previously utilized by software platform 122 with service provider server 130.

Integration discovery application 141 may transmit a response 180 to request 172 from application 112 with integration data of the existing and/or previously used integrations, which may allow the merchant to view the integrations and information for those integrations, such as the computing service used, the API request/response parameters, other call parameters, an integration type, an integration platform, and/or an integration channel. Additionally, with response 180 or based on a further request from application 112, code transformer application 145 may be invoked to transform code for the provided integrations to new or updated code, APIs, and the like. Code transformer application 145 may receive an API call transformation request 182 from integration discovery application 141 based on an existing API call or other code integration. API call transformation request 182 may designate the existing/legacy and target/new parameters, which may utilize limitation mappings 196 to map code limitations for the existing/legacy to code limitations that may be utilized for the target/new parameters. These mapped code limitations allow for code transformation 198 to be generated, which transform computing code and corresponding code limitations of code integrations on software platform 122 to new code integrations usable with software platform 122.

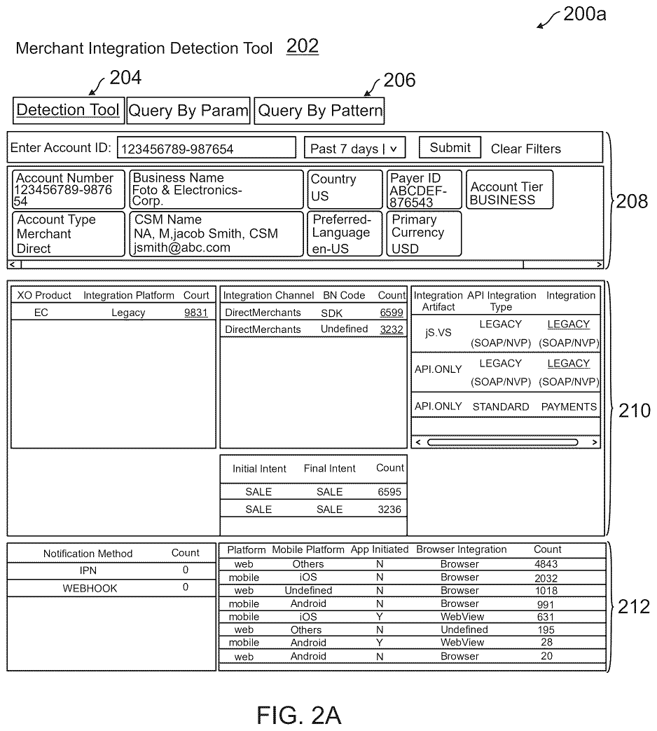

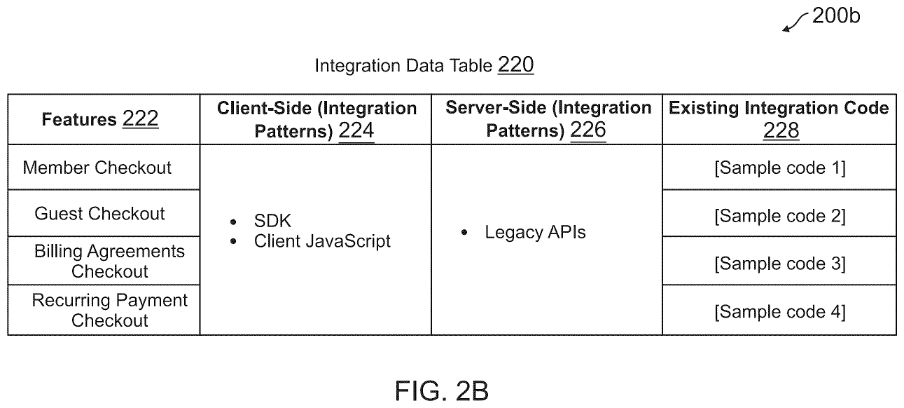

FIGS. 2A and 2B are exemplary diagrams 200a and 200b of a detection tool for detection and presentation of integration patterns and code utilized by software platforms with corresponding updates available for new computing code, according to an embodiment. Diagrams 200a and 200b include exemplary fields of a merchant integration detection tool 202 that may be provided in one or more UIs presentable on a client device of a user, such as in application 112 of merchant device 110, as discussed in reference to systems 100a and 100b of FIGS. 1A and 1B. For example, merchant integration detection tool 202 may be accessible through integration update platform 140 or other online digital platform of a service provider. Merchant integration detection tool 202 may correspond to a computing application tool or other process of integration discovery application 141, and may enable merchants or other entities and their employees (e.g., agents, code developers, users, teams, etc.) to perform code integration discovery and determination for the legacy computing code integrations of a software platform with those of the computing services provided by service applications 132. In this regard, diagrams 200a and 200b include fields having data for current integrations 144 after determination by integration discovery application 141 using merchant accounts 142, API call data 143, and other information known or accessible for code integrations of software platforms with computing services.

Referring now to diagram 200a of FIG. 2A, an embodiment of the data fields presented by integration discovery application 141 of integration update platform 140 is shown when data for current integrations 144 is requested, such as by merchant device 110 to update software platform 122 on merchant server 120. Merchant integration detection tool 202 includes a detection tool 204 and a query tool 206. Detection tool 204 allows for merchants to detect and discover their current code integrations of their software platforms with computing services. For example, with reference to FIG. 1B, merchant device 110 may transmit request 172 to integration discovery application 141 to determine integrations with computing services provided by service applications 132 using detection tool 204. While request 172 may generally request the detection of all code integrations of the merchant's software platform using detection tool 204, a more specific request by querying based on API or code parameter and/or pattern may be performed using query tool 206. For example, an API parameter for a legacy code integration may be specified or a pattern to API calls, call structures, endpoint communication, and/or other functionality may be specified using query tool 206.

To present the fields in diagram 200a, integration discovery application 141 may process information for merchant accounts 142 and/or API call data 143. As previously discussed, merchant accounts 142 may be associated with past and/or existing code integrations, while API call data 143 may be linked to exchanged or received API calls and/or responses that enable integration discovery application 141 to determine and/or infer the computing code used for service integration, API calls, endpoint usage, and/or other information for code integrations. Merchant integration detection tool 202 may then display or output a merchant information field 208, a legacy service integration field 210, and a legacy platform integration field 212. Although merchant integration detection tool 202 in diagram 200a is presented as an interface of an application tool or process, such as one that may be viewed through a UI of an application or webpage, other types and appearances of data visualizations, representations, and implementations of merchant integration detection tool 202 and corresponding fields shown in diagram 200a may also be utilized and/or displayed by the corresponding tool, application, or webpage. For example, merchant integration detection tool 202 may instead be presented through one or more menus, browsable fields, audiovisual content, and/or other media and visualizations of data.

In this regard, merchant information field 208 may display data for the different information determined for the merchant, the merchant's account, the merchant's history, and/or other information that may be relevant to the merchant's software platform and/or code integrations. For example, merchant information field 208 is shown with an account identifier (ID) and/or account number, an account type, a business name, a customer support/success manager (CSM) name, a country, a payer identifier, a primary currency, and/or an account tier. Merchant information field 208 may be used by the merchant to view any information related to their account and/or software platform, which may have been used to determination of code integration updates.

In order to update legacy code integrations, the merchant may further be required to known and view their existing and/or legacy code integrations. In this regard, legacy service integration field 210 and legacy platform integration field 212 may provide the corresponding information to the merchant. For example, legacy service integration field 210 may include information regarding the computing service products that have been integrated and how they have been integrated with the merchant's software platform including integration platforms, integration channels, build notation code, integration artifact, API integration type, integration, initial/final process intent, payment method, currency, etc. For legacy platform integration field 212, a platform (e.g., mobile or web), a mobile OS platform, whether the API calls were initiated by an application or browser, and/or a browser integration may be provided for the legacy platform integrations of the merchant's software platform. Each integration may have a corresponding count for the number of integration patterns detected, such as the exchanged calls or other processes. As such, a resulting output in one or more UIs of application 112 may include legacy service integration field 210 and legacy platform integration field 212 that are displayed for legacy limitations 114 for the merchant integrations 113 of software platform 122.

Referring now to diagram 200b of FIG. 2B, an integration data table 220 for code integrations that may be presented in one or more UIs is shown, such as a tabular data format for data associated with legacy service integration field 210. In this regard, integration data table 220 includes features 222, a client-side integration 224, a server-side integration 226, and existing integration code 228. Integration data table 220 may be generated by integration discovery application 141, such as based on API calls 176 to APIs 190 to determine call data 192 and/or from fetch commands 178 to database 136 for past merchant integration data 194. Although diagram 200b is presented as a table that may be seen in a UI of an application or webpage, other visualizations, representations, and implementations of the data shown in diagram 200b may also be utilized. For example, integration data table 220 may instead be presented through one or more menus, browsable fields, audiovisual content, and/or other media and visualizations of data.

Integration data table 220 includes data that may provide a merchant with information regarding the currently implemented code integrations that the merchant's software platform has with service applications 132 to provide their computing services via software platform 122. Features 222 may correspond to these computing services, such as a member checkout process, a guest checkout process, a billing agreements checkout process, and/or a recurring payment checkout process. Each of these checkout processes may correspond to a checkout and payment process provided by service applications 132, such as a transaction processing application. The processes may be implemented on and/or through software platform 122 to enable customers of the merchant to checkout directly, or navigate to a linked checkout, on software platform 122.

However, when implementing features 222 on software platform 122, client-side integration 224 and server-side integration 226 are required to facilitate the exchange of calls and other operations. In this regard, client-side integration 224 may correspond to the integration patterns utilized client-side by the client (e.g., software platform 122 on merchant server 120) calling the server (e.g., service provider server 130, and specifically, the APIs of service applications 132). As such, client-side integration 224 may correspond to one or more standardized methods of integrating and exchanging data by a client implementing client-side integration 224 with the APIs, applications, and computing services of the correspond server. For example, client-side integration 224 may be used by the client calling service applications 132, such as software platform 122, which may be used to facilitate software platform 122 with utilizing service applications 132.

For the corresponding integration patterns utilized server-side for interfacing with the client, server-side integration 226 may identify the corresponding server-side APIs called by the client using client-side integration 224. Server-side integration 226 may identify those APIs, endpoints, and other server-side data, operations, applications, and the like that may be utilized by software platform 122 when calling service applications 132 for computing service usage. For example, server-side integration 226 is shown in diagram 200b identifying legacy API endpoints used by the integration of software platform 122 when calling the corresponding server's computing services.

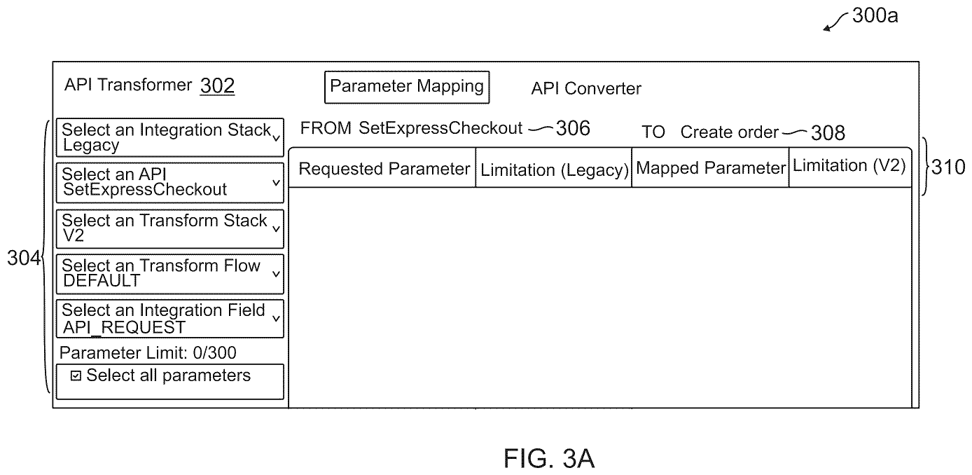

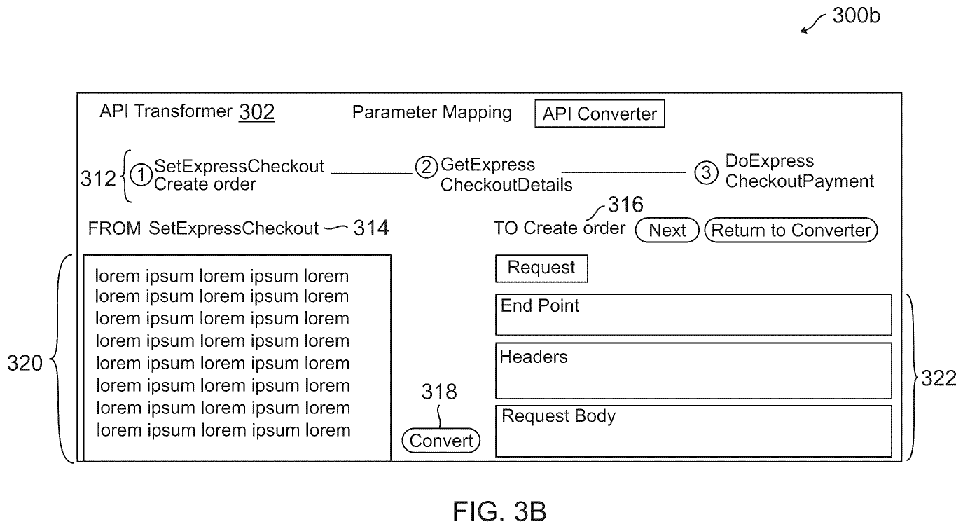

Client-side integration 224 may include an SDK and/or client JavaScript as implemented computing code to call legacy APIs from server-side integration 226. To provide these code integrations, existing integration code 228 may also be presented in integration data table 220, allowing the merchant to review and identify the code limitations used for computing service integration with software platform 122. As such, existing integration code 228 may be required to be updated to no longer utilize legacy APIs for server-side integration 226, as shown in FIGS. 3A and 3B below using a code transformer.

FIGS. 3A and 3B are exemplary diagrams 300a and 300b of a code transformation tool that transforms legacy computing code for integrations of software platforms with computing services to new computing code, according to various embodiments. Diagrams 300a and 300b show an exemplary interface, layout, and/or presentation of an API transformer 302, such as API call transformer 147 of code transformer application 145 when presented in application 112 of merchant device 110, as discussed in reference to systems 100a and 100b of FIGS. 1A and 1B. For example, API transformer 302 may be accessible through integration update platform 140 or other online digital platform of a service provider. API transformer 302 may correspond to a computing application tool or other process provided by API call transformer 147, which may be used to transform legacy API calls and call structures to new calls and executable code for such calls, for example, using mappings 146 of legacy parameters and code limitations to new parameters and code limitations. A merchant may access API transformer 302 to update existing integration code 228 to new integrations.

In diagram 300a of FIG. 3A, API transformer 302 may be placed in a setting or mode for parameter mapping, whereby parameters for API calls or other code may be mapped between different versions, updates, or implementations of integrations of those parameters. For example, parameters for API calls may be mapped from a legacy version of the code for those API calls to a new or current version of such calls, which may allow for use of new APIs, computing services, and the like. In this regard, mappings 146 may be utilized for parameter mapping by API transformer 302, which may allow for old, existing, or legacy code implemented by code and integrations 124 on software platform 122 to be mapped to new code (e.g., to map legacy limitations 114 to new limitations 115). As such, a merchant viewing existing integration code 228 may be able to obtain new code to better implement those integrations.

The system may accept selections from transformation options 304, which designate the existing integration stack, the API, the transformation stack (e.g., the target or new integration and processing corresponding processor stack), a transformation flow, and an integration field (e.g., the API call, such as a request, response, etc.). For example, selections from transformation options 304 may be performed by the merchant (e.g., when a single individual or group of individuals act as a merchant), a merchant software and/or code developer, or another merchant employee or agent. However, selection may also be automated and/or performed programmatically, such as using an automated computing script, a generative AI, or the like, which may intelligently predict and/or make selections when transforming integration code on behalf of a merchant, developer, or other user or entity.

The selections may include selection and/or identification of parameters for mapping by API transformer 302, such as the particular code limitation for a variable, option, action, or the like that is to be executed by the code, such as data passed with the API call. As such, a selection of one or more of transformation options 304 may cause mapping of legacy code integration 306 for the API to new code integration 308. This shows the requested parameter and legacy limitation for legacy code integration 306 to be mapped by mappings 146 to a mapped parameter and new version limitation for new code integration 308. As such, the merchant may view a field showing the parameter and the code limitations, which allows the merchant to identify the parameter and code for legacy code integration 306 with software platform 122 and update to new code integration 308 with software platform 122.

Referring now to diagram 300b of FIG. 3B, API transformer 302 is shown in an API converter setting or mode where a merchant may provide computing code for a legacy or other existing integration that the merchant has and which the merchant would like to convert to a new integration. For example, mappings 146 may be utilized by an executable process of API call transformer 147 to convert code that the merchant may provide to new code that the merchant may implement to update their code integrations. For example, with API transformer 302, integration conversions 312 in a processing flow, such as a flow of API calls for order processing and/or payment, may be selectable and/or updateable for each of the integrations utilized in that processing flow of software platform 122. Integration conversions 312 allow the merchant to proceed through a processing flow when updating their corresponding legacy integrations to new integrations.

After a selection from integration conversions 312, a legacy integration field 314 may be usable to enter legacy code for conversion to new code that may be provided in a new integration field 316 for the selected one of integration conversions 312. For example, a convert option 318 may be selected and input code 320 of an API call in a legacy form may be provided to convert input code 320 to output code 322 for an API call in a new form. As such, code generation of new code limitations and/or configuration of code templates for new code integrations may not be required to be performed manually and/or without automation. Instead, API transformer 302 may automatically generate code limitations using input code 320 for legacy integration field 314 and selecting convert option 318. Once selected, mappings 146 may be utilized by API transformer 302 to convert the code, such as by tailoring the code limitations for the new code to those utilized for the mapped parameters in the legacy code of the merchant. Output code 322 may then be output and/or displayed in new integration field 316, which may then be copied, downloaded, and/or extracted by a developer for the merchant, a script or generative AI, or other user or entity and utilized with their software platform to update code integrations. In some embodiments, this may correspond to converting API calls using a legacy API specification and endpoints to REST API calls to REST endpoints for a REST API, which may be specified by a REST API specification for the REST API.

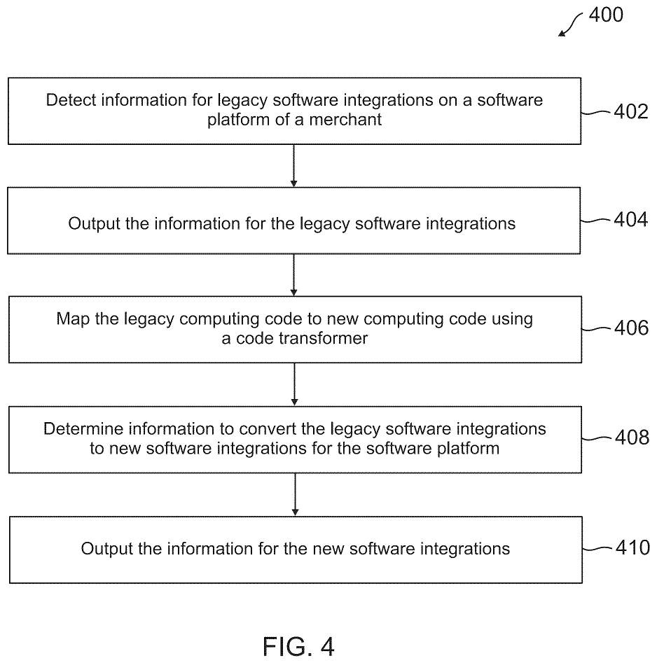

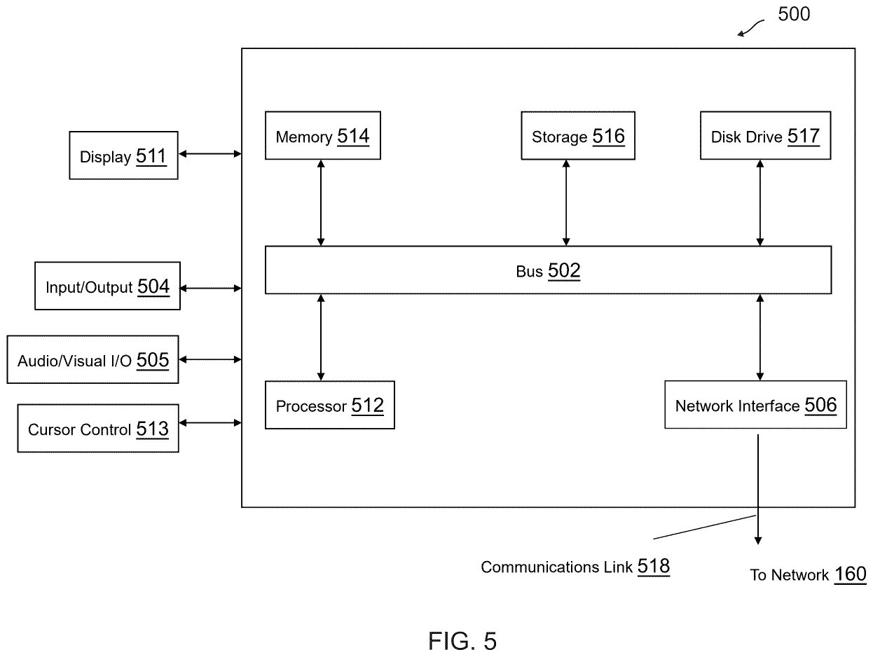

FIG. 4 is a flowchart 400 for automated updating of computing code for software platform integrations with computing services, according to an embodiment. For example, flowchart 400 may be performed by integration update platform 140 using integration discovery application 141 with code transformer application 145. In this regard, integration update platform 140 may receive a request from application 112 on merchant device 110 to discover and/or view merchant integrations for software platform 122 on merchant server 120 with service applications 132 on service provider server 130. In other embodiments, the request need not be received by merchant device 110, but instead be received by another device or entity, including the service provider, such as after a certain time has passed since a last code or integration check or update or a new code update or integration for the service provider has occurred. In such a case, the merchant may not need to make a request to discover and/or view merchant integrations or may make it upon a notification from the service provider. Integration discovery application 141 may utilize merchant accounts 142, API call data 143 to determine current integrations 144, which may include legacy limitations 114 for computing code and other integrations of code and integrations 124 for software platform 122. Thereafter, code transformer application 145 may utilize mappings 146 with API call transformer 147 to convert legacy limitations 114 to new limitations 115 that may be presented to the merchant in application 112 and used to update code and integrations 124. Note that one or more steps, processes, and methods described herein of flowchart 400 may be omitted, performed in a different sequence, or combined as desired or appropriate.

At step 402 of flowchart 400, information for legacy software integrations on a software platform of a merchant is determined. For example, in system 100a of FIG. 1A, a merchant associated with merchant device 110 may want to update and/or migrate a previous or “legacy” (e.g., old, past version, outdated, etc.) integration of computing code to a new, updated, or currently available integration, such as a new version of the code, a new computing service, and/or one or more new APIs. The computing code may be used to integrate software platform with a computing service of service provider server 130, such as a service provided using or through service applications 132. For example, the integration may facilitate the use, transmission, and/or exchange of integrations calls 134, such as API calls to an API of service applications 132 for computing service use. These integrations allow the computing services of service provider server 130 to be provided on other separate and/or third-party platforms.

To determine legacy software integrations, merchant information, such as the information associated with merchant accounts 142, may be provided and/or determined, such as information regarding the past or existing integrations that software platform 122 has with service applications 132 and the corresponding computing services, APIs, and the like. The information for determination of legacy software integrations may also include information regarding software platform data, code, and/or code requirements (e.g., capabilities, specifications, SDDs, etc.) of software platform 122, as well as any APIs and API documentation, API calls and structures, code snippets, packages, files, written code, and/or other executable computing code. In some embodiments, this may include existing code and/or legacy code and code integrations, such as legacy API integrations and specifications used to call legacy APIs of the service provider (e.g., older and/or out-of-date APIs). Further, integration discovery application 141 may execute API calls to ping, fetch data from, or request responses from software platform 122, which may include API call data 143 for those exchanged calls. Where the software integration may be a legacy software integration that utilizes a past SDK or a past API specification for API request and response parameters previously used by an API of the computing service, such information may be retrieved and/or determined from merchant responses and input.

At step 404, the information for the legacy software integrations is output, for example, to a user associated with the merchant (e.g., a code developer, agent, employee, or other user that may be working on behalf of the merchant for code integration updates) and/or to an automation performing code integration updates. Integration discovery application 141 may output data for current integrations 144 on merchant device 110 via application 112. For example, merchant integrations 113 may be output in application 112 having displayable data for the legacy code integrations, such as legacy limitations 114 having the code limitations, snippets, or statements used to integrate the computing service with software platform 122. As such, application 112 may include one or more UIs displaying data for merchant integrations 113 to a developer, agent, employee, or other user utilizing merchant device 110 on behalf of the merchant to update code integrations with software platform 122. However, in other embodiments, merchant integrations 113 may be output to a script, generative AI, or other automation that may perform code updates and migrations of code integrations to new code, systems, APIs, and the like. As such, the developer or other user associated with the merchant may view their legacy integrations so that updates may be performed, such as by utilizing new limitations 115 to implement new integrations that update the legacy integrations, or an automation may receive output data for merchant integrations 113 to perform such updates.

At step 406, the legacy computing code is mapped to new computing code using a code transformer. In addition to presenting legacy limitations 114 in a UI of application 112, new limitations 115 may be determined from mappings so that the merchant may determine a process, code, and/or information that may be used to update the legacy integrations by replacing, updating, or changing legacy limitations 114. For example, code transformer application 145 may utilize mappings 146 that may include mapped API call parameters or other parameters associated with executable code for service-to-service interactions and call exchanges. The mapped parameters may include the legacy, past, and/or previous version of a parameter mapped to the new, updated, and/or target parameter. Further, the mappings may include, for each parameter, a corresponding code limitation such that by mapping a legacy parameter to a new parameter, a legacy limitation may be mapped to a new limitation for the computing code to be used. This allows for legacy limitations 114 to be mapped to new limitations 115 using mappings 146.

At step 408, information to convert the legacy software integrations to new software integrations for the software platform is determined. In order to integrate a computing service associated with service applications 132 with application 112 so that integration calls 134 may be made by software platform 122 to service applications 132, an update to code and integrations 124 may be determined, such as a code package, statement, and/or API call. In this regard, API call transformer 147 may utilize mappings 146 to determine the specific change to the computing code, which may be generated and/or determined for deployment with code and integrations 124. For example, API call transformer 147 may transform the legacy API calls to the new API calls to be used, or may determine other data for code deployment including an SDK, code snippets or packages, API call samples, and/or API call parameters and code limitations or configurations. Where the software integration is a legacy one utilizing a past SDK and/or past API specification, the new code may update the computing code based on an updated SDK and/or an updated API specification. This updated API specification may utilize one or more REST endpoints associated with a REST API for the computing service, and as such, API call transformer 147 may convert the legacy API calls to new API calls to REST endpoints with a REST API.

At step 410, the information for the new software integrations is output, for example, to a code developer, an agent, an employee, or other user associated with the merchant and/or to an automation that may be performing or assisting with performance of code integration updates. Integration update platform 140 may provide data for one or more UIs where a user utilizing merchant device 110 may utilize application 112 to view merchant integrations 113 and interact with integration discovery application 141 and/or code transformer application 145. In this regard, a UI provided by integration update platform 140 may be output via application 112 including the computing code for conde integrations configured for software platform 122 of the merchant. Application 112 may provide one or more UIs to access, view, and interact with a portal and platform where a user utilizing merchant device 110 may receive, view, and/or interact with merchant integrations 113. The user may utilize application 112 with integration update platform 140 to implement new limitations 115 with software platform 122.

In further embodiments, automations, including scripts, generative AIs, and/or other intelligent and/or automated systems, bots, applications, and the like, may utilize integration update platform 140 for code integration updates on behalf of a merchant. The merchant may correspond to merchant device 110 and merchant server 120, such as a merchant business or other entity that utilizes software platform 122 as a merchant sales and/or marketplace platform. As such, the automation may obtain the information from step 410 for integration updates and/or implementation of the new software integrations. Additionally, chatbots 148 may be utilized to provide an intelligent conversational platform and process that a user associated with a merchant may utilize to request and receive information for merchant integrations 113. For example, chatbots 148 may correspond to conversational AIs, such as bots that may utilize LLMs or other generative AIs, to enable the user to interact with integration discovery application 141 and/or code transformer application 145 through natural language input and/or question-and-answer format and statements.

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with network 160. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, and/or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), and/or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, and/or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, and/or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
detect a software integration of a software platform of a merchant with a computing service associated with a service provider;
determine information associated with the software integration and the merchant, wherein the information is associated with computing code being used for the software integration and an account of the merchant;
convert the computing code to new computing code using a code transformer and based on one or more mappings of input parameters associated with the computing code to new parameters of the computing service after one or more changes to the computing service;
generate a new software integration for the software platform of the merchant with the computing service based on the new computing code; and
output the new software integration to the merchant via a user interface.

2. The system of claim 1, wherein detecting the software integration comprises:
receiving a request to access an interface of a service that migrates the software integration to the new software integration; and
determining the software integration using a tool that retrieves account information for the account of the merchant and executes application programming interface (API) calls to a merchant API of the software platform of the merchant.

3. The system of claim 1, wherein the software integration comprises a legacy software integration that utilizes at least one of a past software development kit (SDK) or a past API specification for API request and response parameters previously used by an API of the computing service, and wherein the new computing code, when executed, updates the computing code based on at least one of an updated SDK or an updated API specification.

4. The system of claim 3, wherein the updated API specification utilizes one or more representational state transfer (REST) endpoints associated with a REST API for the computing service.

5. The system of claim 1, wherein each of the one or more mappings comprises one of the input parameters for a legacy API call structure mapped to one of the new parameters for a new API call structure, and wherein the one of the input parameters is associated with a legacy code limitation and the one of the new parameters is associated with a new code limitation.

6. The system of claim 5, wherein the legacy API call structure and the new API call structure are associated with at least one of an endpoint or a data object, and wherein the new code limitation provides a notification of a change or a warning based on the endpoint or the data object specified by the new API call structure.

7. The system of claim 1, wherein the instructions are further configured, when executed, to cause the system to:
call an API of the code transformer based on the information, wherein calling the API includes requesting the code transformer convert the computing code to the new computing code using the one or more mappings and a sample of an API call for the software integration.

8. The system of claim 1, wherein detecting the software integration is based on a request from the merchant via a chatbot associated with the code transformer, wherein the information is determined, in part, from the merchant during a chat session between the merchant and the chatbot, and wherein outputting the new software integration to the merchant is via the chatbot.

9. The system of claim 1, wherein converting the computing code to the new computing code is further based on an API call structure provided by the merchant for the software integration.

10. A method comprising:
determining a first software integration of a platform of an entity with a computing service associated with a service provider based on a request to update the first software integration, wherein the first software integration is associated with first computing code for first application programming interface (API) calls to a first API of the computing service previously used by the platform;
determining account information for an account of the entity, wherein the account information indicates one or more usages of the computing service on the platform;
generating second computing code that, when executed, updates the first computing code for second API calls to a second API of the computing service using a code transformer and based on one or more mappings of API parameters associated with the first API to the second API; and
communicating, to the entity, the second computing code that enables a second software integration.

11. The method of claim 10, wherein each of the one or more mappings of the API parameters comprise a first API parameter associated with a first code limitation mapped to a second API parameter associated with a second code limitation.

12. The method of claim 11, wherein the first code limitation and the second code limitation comprise computing code that, when executed, enable the first API calls and the second API calls, respectively, to the computing service.

13. The method of claim 10, wherein the code transformer generates the second computing code by converting first data in API fields in the first API calls to second data in the API fields for the second API calls.

14. The method of claim 10, wherein the determining the first software integration is performed using a detection tool, and wherein the method further comprises:
executing, using the detection tool, one or more third API calls to the platform of the entity.

15. The method of claim 14, wherein the one or more third API calls are used to detect the first software integration of the platform with the computing service.

16. The method of claim 10, wherein the first software integration comprises a legacy integration using legacy code for the computing service, and wherein the second software integration is utilized to update the legacy code to new code currently utilized with the computing service.

17. The method of claim 10, wherein the communicating the second computing code to the entity is performed using at least one of a user interface or a chatbot provided by the service provider to the merchant.

18. The method of claim 10, wherein the generating the second computing code is further based on an API call structure provided by the merchant for the second software integration.

19. A non-transitory machine-readable medium having stored thereon machine-readable instructions executable to cause a machine to perform operations comprising:
receiving a request for software integration of a platform of a merchant with a computing service associated with a service provider, wherein the request identifies first computing code for first application programming interface (API) calls to an API of the computing service, and wherein the software integration changes the first computing code to second computing code for second API calls to the API;
determining a mapping of a first API parameter for the first API calls to a second API parameter of the second API calls, wherein the mapping identifies a first code limitation for the first API parameter and a second code limitation for the second API parameter;
generating the second computing code associated with the second API calls based on the mapping; and
communicating, to the merchant via user interface viewable by the merchant, the second computing code that enables the software integration.

20. The non-transitory machine-readable medium of claim 19, wherein prior to the receiving the request, the operations further comprise:
populating the user interface with a plurality of current software integrations of the merchant with a plurality of computing services of the service provider.
